(19) United States
(12) Patent Application Publication
(10) Pub. No.: US 2026/0112820 A1
(43) Pub. Date: Apr. 23, 2026

(54) ARRAY ANTENNA

(71) Applicant: Murata Manufacturing Co., Ltd., Nagaokakyo-shi (JP)

(72) Inventors: Ryotaro OHASHI, Nagaokakyo-shi (JP); Shinya MIZOGUCHI, Nagaokakyo-shi (JP); Masaya OKAZAKI, Nagaokakyo-shi (JP); Yoshihisa KIMURA, Nagaokakyo-shi (JP); Kengo ONAKA, Nagaokakyo-shi (JP); Yoshiki YAMADA, Nagaokakyo-shi (JP)

(73) Assignee: Murata Manufacturing Co., Ltd., Nagaokakyo-shi (JP)

(21) Appl. No.: 19/357,116

(22) Filed: Oct. 14, 2025

(30) Foreign Application Priority Data
Oct. 17, 2024 (JP) 2024-182066

(51) Int. Cl. H01Q 21/06; H01Q 21/00

(52) U.S. Cl. CPC H01Q 21/065; H01Q 21/0006

(57) ABSTRACT

Multiple subarrays are arranged on a board, each including two radiating elements arranged two-dimensionally in first and second directions that are parallel to the in-plane direction of the board and perpendicular to each other. The subarrays are arranged along a straight line in the first direction, forming multiple subarray rows. Each radiating element includes a conductor pattern having a pair of first edges parallel to a third direction inclined with respect to the first and second directions, and a pair of second edges perpendicular to the third direction. The spacing in the second direction between lines parallel to the first direction that connect the geometric centers of the multiple subarrays included in each of the multiple subarray rows is narrower than the dimension of each of the multiple subarrays in the second direction.

### CROSS-REFERENCE TO RELATED APPLICATION

The present application claims priority to Japanese patent application JP 2024-182066, filed Oct. 17, 2024, the entire contents of which being incorporated herein by reference.

### TECHNICAL FIELD

The present disclosure relates to an array antenna.

### BACKGROUND ART

Patent Document 1 discloses an array antenna that can perform beam steering in both azimuth direction and elevation direction and suppress an increase in the number of targets for phase shift control. In this conventional array antenna, one subarray is composed of four radiating elements arranged in two rows and two columns, and multiple subarrays are arranged two-dimensionally in a first direction and a second direction that are orthogonal to each other.

The multiple subarrays are arranged along a straight line in the first direction. In the second direction, one of two subarrays adjacent to each other in the second direction is arranged with a shift in the first direction relative to the other subarray. Therefore, the arrangement pitch of the subarrays in the first direction becomes small overall. As a result, the deflection angle of the beam in the first direction becomes large.

### PRIOR ART DOCUMENT

### Patent Document

[Patent Document 1] JPA2018-186337

### SUMMARY

### Problems to be Solved

In conventional array antennas, the beam deflection angle increases in a first direction in which multiple subarrays are arranged in a straight line, but the beam deflection angle does not increase in a second direction perpendicular to the first direction. The present disclosure is directed to providing an array antenna that is able to increase the beam deflection angle in a direction perpendicular to the direction in which multiple subarrays are arranged along a straight line.

### Means for Solving the Problems

According to one aspect, there is provided an array antenna including:
a board; and
a plurality of subarrays, each having a plurality of radiating elements, arranged two-dimensionally in a first direction and a second direction that are parallel to the in-plane direction of the board and orthogonal to each other, and arranged along straight lines in the first direction to form a plurality of subarray rows;
wherein the plurality of radiating elements included in each of the subarrays include conductor patterns having a pair of first edges parallel to a third direction inclined with respect to the first direction and the second direction, and a pair of second edges orthogonal to the third direction, and
wherein the spacing in the second direction between straight lines parallel to the first direction that connect geometric centers of the subarrays included in each of the subarray rows is narrower than the dimension of each of the subarrays in the second direction.

According to another aspect, there is provided an array antenna including:
a multilayer board; and
a plurality of subarrays, each including a plurality of radiating blocks, arranged two-dimensionally in a first direction and a second direction parallel to an in-plane direction of the multilayer board and orthogonal to each other, and arranged along a straight line in the first direction to form a plurality of subarray rows;
wherein:
each of the plurality of radiating blocks includes a dielectric board mounted on the multilayer board and a radiating element formed on the dielectric board;
each of the plurality of radiating elements includes a conductor pattern having a pair of first edges parallel to a third direction inclined with respect to the first direction and the second direction, and a pair of second edges orthogonal to the third direction;
each of the dielectric boards is square or rectangular in a plan view, with edges parallel to the first edges and the second edges of each of the radiating elements; and
when focusing on two subarray rows adjacent to each other in the second direction, each of the plurality of radiating blocks of the plurality of subarrays included in one subarray row is arranged so as to partially overlap with any one of the plurality of radiating blocks included in the other subarray row in the first direction.

### Advantageous Effects

The spacing in the second direction between the straight lines parallel to the first direction connecting the geometric centers of the multiple subarrays included in each of the multiple subarray rows is narrower than the dimension of each of the multiple subarrays in the second direction, thereby increasing the deflection angle of the beam in the second direction.

### BRIEF DESCRIPTION OF THE DRAWINGS

FIG. 1A is a plan view of one subarray 10 constituting the array antenna according to the first embodiment, and FIG. 1B is a plan view of the array antenna according to the first embodiment.

FIG. 2 is a block diagram of an antenna module equipped with an array antenna according to the first embodiment.

FIG. 3 is a cross-sectional view of a portion of the antenna module shown in FIG. 2.

FIGS. 4A and 4B are plan views of one subarray 10 of the array antenna according to a modification of the first embodiment.

FIG. 5A is a plan view of one subarray 10 of the array antenna according to the second embodiment, and FIG. 5B is a plan view of the array antenna according to the second embodiment.

FIG. 6A is a plan view of one subarray 10 of the array antenna according to the third embodiment, and FIG. 6B is a plan view of the array antenna according to the third embodiment.

FIG. 7 is a plan view of an array antenna according to the fourth embodiment.

FIG. 8 is a cross-sectional view of a portion of an array antenna according to the fifth embodiment.

FIG. 9 is a plan view of the array antenna according to the fifth embodiment.

FIG. 10 is a cross-sectional view of a portion of an array antenna according to the sixth embodiment.

FIG. 11 is a diagram showing the positional relationship in a plan view of a plurality of radiating blocks 15, a plurality of first rods 31, and a plurality of second rods 32 of the array antenna according to the sixth embodiment.

FIG. 12 is a graph showing the simulation results of the realized gain in the boresight direction of the array antenna.

FIG. 13 is a cross-sectional view of a portion of an array antenna according to the modification of the sixth embodiment.

### DETAILED DESCRIPTION

### First Embodiment

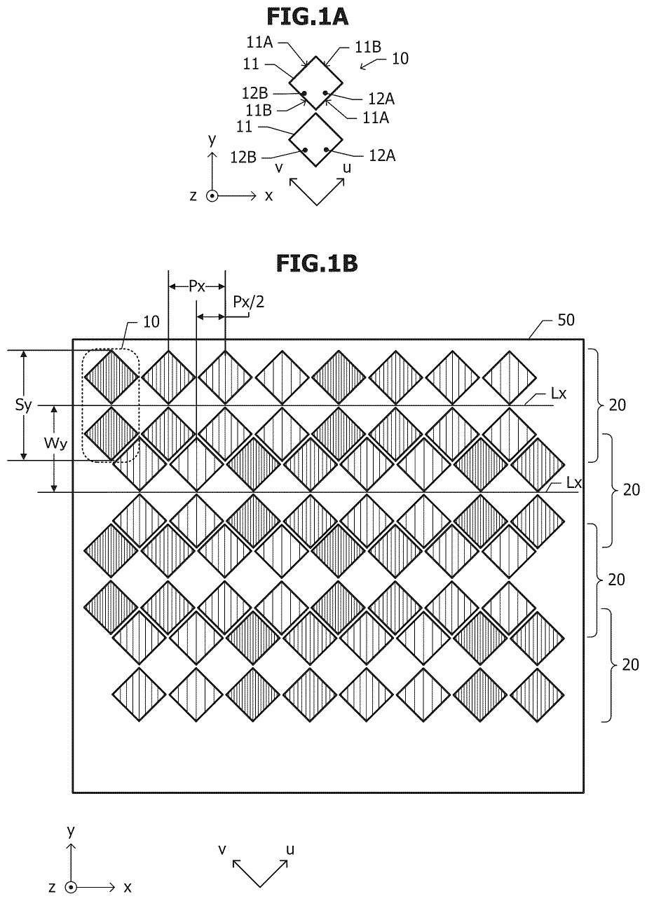

An array antenna according to a first embodiment will be described with reference to FIGS. 1A to 3.

FIG. 1A is a plan view of one subarray 10 constituting the array antenna according to the first embodiment. The subarray 10 includes two radiating elements 11. As will be described later with reference to FIG. 1B, the multiple subarrays 10 are arranged two-dimensionally in a first direction (hereinafter referred to as the x-direction) and a second direction (hereinafter referred to as the y-direction) that are parallel to a primary plane of a board on which the subarrays are arranged and orthogonal to each other. A direction normal to this primary plane is referred to as the boresight direction. The two radiating elements 11 are arranged in parallel in the y-direction. In other words, the straight line connecting the geometric centers of the two radiating elements 11 is parallel to the y-direction.

The radiating element 11 is configured with a conductor pattern including a pair of first edges 11A parallel to a third direction tilted with respect to the x-direction and the y-direction (hereinafter referred to as the u-direction), and a pair of second edges 11B parallel to a direction perpendicular to the u-direction (hereinafter referred to as the v-direction). In the first embodiment, the u-direction is tilted at an angle of 45° with respect to the x-direction. The shape of the radiating element 11 in a plan view is a square or rectangle. The shape of the radiating element 11 may also be a square with rounded corners, a rectangle with rounded corners, a square or rectangle with the vertices cut-off in a triangular shape, or the like.

Each of the radiating elements 11 is provided with a first feed point 12A and a second feed point 12B. For example, the first feed point 12A is located slightly inward from the midpoint of one of the first edges 11A, and the second feed point 12B is located slightly inward from the midpoint of one of the second edges 11B. The radio wave radiated when power is supplied to the first feed point 12A and the radio wave radiated when power is supplied to the second feed point 12B are linearly polarized waves that are orthogonal to each other. When one of the radiating elements 11 is translated in the y-direction, it overlaps the other radiating element 11, and the first feed point 12A and the second feed point 12B of one of the radiating elements 11 also overlap the first feed point 12A and the second feed point 12B of the other radiating element 11, respectively.

FIG. 1B is a plan view of the array antenna according to the first embodiment. Multiple subarrays 10 are arranged two-dimensionally in the x-direction and y-direction parallel to the in-plane directions of the multilayer board 50. In the x-direction, the multiple subarrays 10 are arranged along straight lines to form multiple subarray rows 20. In FIG. 1B, two radiating elements 11 that constitute one subarray 10 are hatched with the same density.

The arrangement pitch in the x-direction of the plurality of subarrays 10 constituting each of the plurality of subarray rows 20 is denoted as Px. Focusing on two subarray rows 20 adjacent to each other in the y-direction among the plurality of subarray rows 20, the plurality of subarrays 10 included in one subarray row 20 are shifted in the x-direction by ½ of the arrangement pitch Px with respect to the plurality of subarrays 10 included in the other subarray row 20. With this arrangement, focusing on the two subarray rows 20 adjacent to each other in the y-direction, each of the plurality of subarrays 10 included in one subarray row 20 overlaps one of the plurality of subarrays 10 included in the other subarray row 20 in the x-direction.

A straight line parallel to the x-direction that connects the geometric centers of the multiple subarrays 10 included in each of the multiple subarray rows 20 is referred to as a straight line Lx. The spacing Wy between the straight lines Lx in the y-direction is narrower than the dimension Sy of each of the multiple subarrays 10 in the y-direction. Here, the dimension Sy of the subarray 10 in the y-direction is defined as the distance from one end to the other end in the y-direction of the region in which two radiating elements 11 are arranged.

That is, a portion of one subarray 10 and a portion of the subarray 10 adjacent thereto in the y-direction are arranged in a common region in the y-direction. In other words, the two subarrays 10 adjacent to each other in the y-direction overlap with respect to the y-direction. This arrangement is possible because the first edge 11A (u-direction) of the radiating element 11 is inclined with respect to the x-direction, and the two subarrays 10 adjacent to each other in the y-direction are shifted in the x-direction.

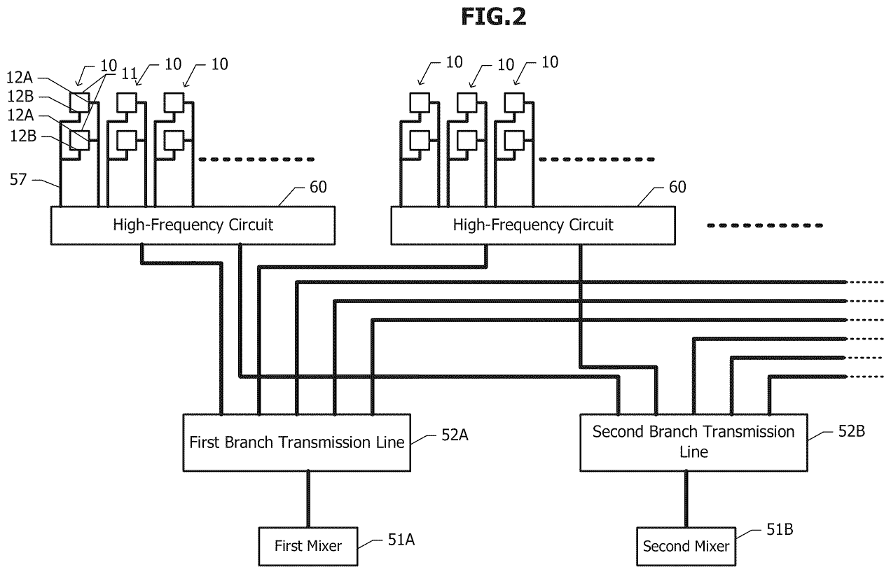

FIG. 2 is a block diagram of an antenna module equipped with an array antenna according to the first embodiment. This antenna module includes a first mixer 51A, a second mixer 51B, a first branch transmission line 52A, a second branch transmission line 52B, a plurality of high-frequency circuits 60, and a plurality of subarrays 10.

The first mixer 51A upconverts a baseband signal or an intermediate frequency signal and inputs the upconverted signal to the first branch transmission line 52A. The first branch transmission line 52A equally distributes the high-frequency signal input from the first mixer 51A to the multiple high-frequency circuits 60. The second mixer 51B upconverts the baseband signal or the intermediate frequency signal and inputs the upconverted signal to the second branch transmission line 52B. The second branch transmission line 52B equally distributes the high-frequency signal input from the second mixer 51B to the multiple high-frequency circuits 60.

Each of the high-frequency circuits 60 has a plurality of antenna terminals, to which the first feed points 12A and the second feed points 12B of the plurality of radiating elements 11 are connected via feed lines 57. The first feed points 12A of the two radiating elements 11 of one subarray 10 are connected to the same antenna terminal, and the second feed points 12B of the two radiating elements 11 of one subarray 10 are connected to the same other antenna terminal. That is, a high-frequency signal branched from one feed line 57 is input to the first feed points 12A of the two radiating elements 11 in the subarray 10, and a high-frequency signal branched from another feed line 57 is input to the second feed points 12B. Each of the high-frequency circuits 60 amplifies the input high-frequency signal, adjusts the phase, and outputs the signal from the plurality of antenna terminals.

The high-frequency signal output from the antenna terminal of the first branch transmission line 52A is input to the first feed points 12A of the multiple radiating elements 11, and the high-frequency signal output from the antenna terminal of the second branch transmission line 52B is input to the second feed points 12B of the multiple radiating elements 11.

The high-frequency circuit 60 combines high-frequency signals received by the radiating elements 11 of the multiple subarrays 10 and inputs the combined signals to the first branch transmission line 52A and the second branch transmission line 52B. The first branch transmission line 52A combines the high-frequency signals input from the multiple high-frequency circuits 60 and inputs the combined signal to the first mixer 51A. The second branch transmission line 52B combines the high-frequency signals input from the multiple high-frequency circuits 60 and inputs the combined signal to the second mixer 51B. The first mixer 51A and the second mixer 51B have the function of down-converting the high-frequency signals input from the first branch transmission line 52A and the second branch transmission line 52B, respectively, to baseband signals or intermediate frequency signals.

The high-frequency circuit 60 has a function of operating the multiple subarrays 10 as a phased array antenna by adjusting the phase of the high-frequency signals supplied to the multiple subarrays 10. The high-frequency circuit 60 having this function is sometimes called a beamforming IC (BFIC).

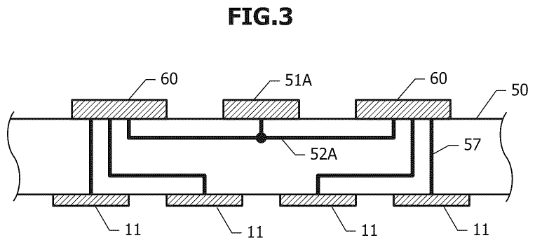

FIG. 3 is a cross-sectional view of a portion of the antenna module shown in FIG. 2. A first mixer 51A and a plurality of high-frequency circuits 60 are mounted on one surface of a multilayer board 50. A plurality of radiating elements 11 are formed on the other surface of the multilayer board 50. Each of the plurality of radiating elements 11 constitutes a patch antenna together with a ground conductor plate provided on the multilayer board 50, for example.

The first mixer 51A is connected to the plurality of high-frequency circuits 60 via the first branch transmission line 52A made of a strip line or a microstrip line arranged in the multilayer board 50.

Each of the plurality of high-frequency circuits 60 is connected to the radiating element 11 via a feed line 57 provided on the multilayer board 50.

Next, the advantageous effects of the first embodiment will be explained.

In the first embodiment, since the effective arrangement pitch of the multiple subarrays 10 in the x-direction is ½ of the arrangement pitch Px of the multiple subarrays 10 in one subarray row 20, the beam deflection angle in the x-direction could be larger. Furthermore, since the effective arrangement pitch of the multiple subarrays 10 in the y-direction is the spacing Wy between the straight lines Lx (FIG. 1B), which is smaller than the dimension Sy of the subarrays 10 in the y-direction, the beam deflection angle in the y-direction could be larger compared to a configuration in which the spacing Wy is wider than the dimension Sy.

Furthermore, since the overall dimension of the array antenna in the y-direction is reduced, the length of the feed line could be shortened. Thus, transmission loss could be reduced.

Furthermore, in the first embodiment, in each of the subarrays 10, two radiating elements 11 are aligned in the y-direction, and the dimension of each of the subarray 10 in the x-direction is equal to the dimension of one radiating element 11. Therefore, compared to a configuration in which, for example, four radiating elements 11 are arranged in two rows and two columns in each of the subarrays 10, the arrangement pitch of the subarrays 10 in the x-direction could be smaller. This allows the beam deflection angle in the x-direction to be increased.

In the first embodiment, the first edge 11A and the second edge 11B of the radiating element 11 are inclined at 45 degrees with respect to the x-direction and the y-direction, so that the edges of the multiple radiating elements 11 aligned along a straight line in the x-direction are not disposed oppositely in parallel to each other. Furthermore, the edges of the two radiating elements 11 in the subarray 10 are also not disposed oppositely in parallel to each other. This makes it possible to improve the isolation between the radiating elements 11.

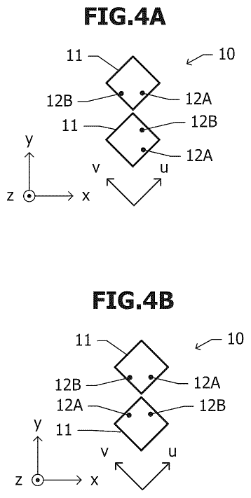

Next, an array antenna according to a modification of the first embodiment will be described with reference to FIG. 4A and FIG. 4B. FIG. 4A and FIG. 4B are plan views of one subarray 10 of the array antenna according to the modification of the first embodiment. In the first embodiment, when one radiating element 11 in the subarray 10 (FIG. 1A) is translated in the y-direction and overlapped with the other radiating element 11, the first feed point 12A and second feed point 12B of one radiating element 11 also overlap the first feed point 12A and second feed point 12B of the other radiating element 11, respectively.

In contrast to this, in the modified example shown in FIG. 4A, when one radiating element 11 is translated in the y-direction and overlapped with the other radiating element 11, the first feed point 12A of one radiating element 11 overlaps the first feed point 12A of the other radiating element 11, but the second feed point 12B does not overlap the second feed point 12B of the other radiating element 11. In this case, a phase difference of 180° may be provided between the high-frequency signals supplied to the second feed points 12B of the two radiating elements 11.

In the modification shown in FIG. 4B, when one radiating element 11 is translated in the y-direction and overlapped with the other radiating element 11, neither the first feed point 12A nor the second feed point 12B of one radiating element 11 overlaps with either the first feed point 12A or the second feed point 12B of the other radiating element 11. In this case, a phase difference of 180° may be applied to the high frequency signals supplied to the first feed points 12A of the two radiating elements 11, and a phase difference of 180° may also be applied to the high frequency signals supplied to the second feed points 12B.

As explained in the modification shown in FIG. 4A and FIG. 4B, when one of the two radiating elements 11 in the subarray 10 is translated to overlap the other, the feed points do not have to overlap. In such a case, the phase of the high-frequency signals supplied to the feed points may be adjusted.

In the first embodiment, each subarray 10 includes two radiating elements 11, but may also include three or more radiating elements 11. For example, the radiating elements 11 that constitute one subarray 10 may be arranged in a row parallel to the y-direction. Alternatively, one subarray 10 may include four radiating elements 11, and the four radiating elements 11 may be arranged in a matrix of two rows and two columns.

### Second Embodiment

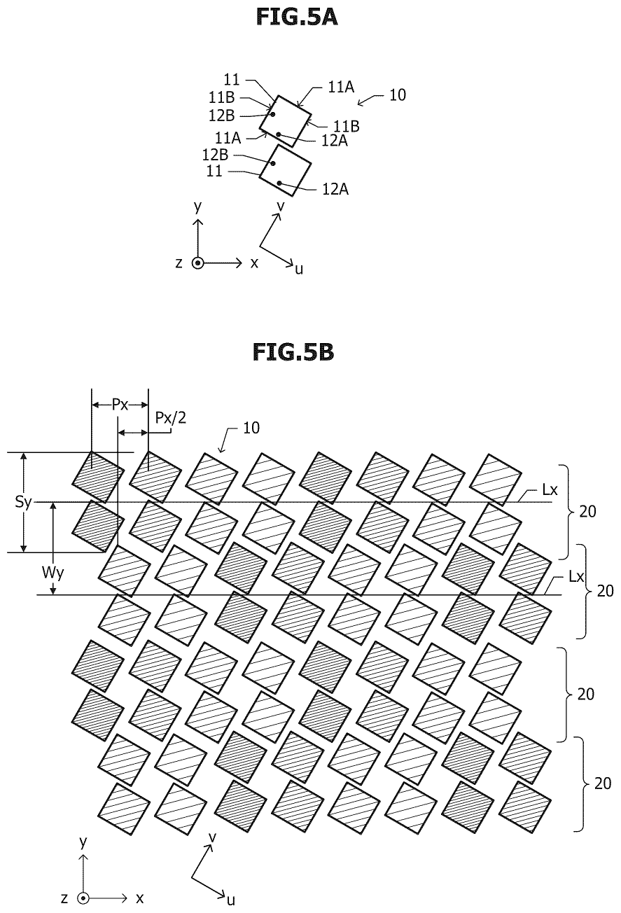

Next, an array antenna according to a second embodiment will be described with reference to FIG. 5A and FIG. 5B. Hereafter, description of the constitutions common to the array antennas according to the first embodiment and its modifications described with reference to FIG. 1A through FIG. 4B will be omitted.

FIG. 5A is a plan view of one subarray 10 of an array antenna according to the second embodiment, and FIG. 5B is a plan view of the array antenna according to the second embodiment. Note that description of the multilayer board 50 (FIG. 1B) is omitted in FIG. 5B. In the second embodiment, multiple subarrays 10 are also arranged two-dimensionally in the x-direction and the y-direction, and are arranged along straight lines Lx in the x-direction. In FIG. 5B, as in FIG. 1B, the two radiating elements 11 that constitute one subarray 10 are hatched with the same density.

As shown in FIG. 5A, in the first embodiment (FIG. 1A), the u-direction and v-direction along which the first edge 11A and the second edge 11B of the radiating element 11 are aligned, are inclined at 45 degrees with respect to the x-direction and y-direction. In contrast, in the second embodiment, the inclination angles of the u-direction and v-direction along which the first edge 11A and the second edge 11B of the radiating element 11 are aligned, with respect to the x-direction and y-direction, are other than 45 degrees. The positional relationship between the two radiating elements 11 is the same as in the first embodiment, and when one radiating element 11 is translated in the y-direction, it overlaps the other radiating element 11.

As shown in FIG. 5B, in the second embodiment, similarly to the first embodiment, when focusing on two subarray rows 20 adjacent to each other in the y-direction among the multiple subarray rows 20, the multiple subarrays 10 included in one subarray row 20 are shifted in the x-direction by ½ of the arrangement pitch Px with respect to the multiple subarrays 10 included in the other subarray row 20.

Furthermore, as in the first embodiment, the spacing Wy in the y-direction between straight lines Lx parallel to the x-direction connecting the geometric centers of the multiple subarrays 10 included in each of the multiple subarray rows 20 is narrower than the dimension Sy of each of the multiple subarrays 10 in the y-direction.

Next, the advantageous effects of the second embodiment will be explained.

In the second embodiment, similarly to the first embodiment, it is possible to increase the beam deflection angle in the x-direction and y-direction, and to improve the isolation between the radiating elements 11.

As in the second embodiment, the inclination angles of the u-direction and v-direction with respect to the x-direction and y-direction are not limited to 45 degrees. Note that as the inclination angle approaches 0 degree, it becomes difficult to make the spacing Wy narrower than the dimension Sy. The inclination angles of the u-direction and v-direction with respect to the x-direction and y-direction may be set to a degree that allows the spacing Wy to be narrower than the dimension Sy. As an example, the inclination angles may be set within the range of 45±15 degrees.

### Third Embodiment

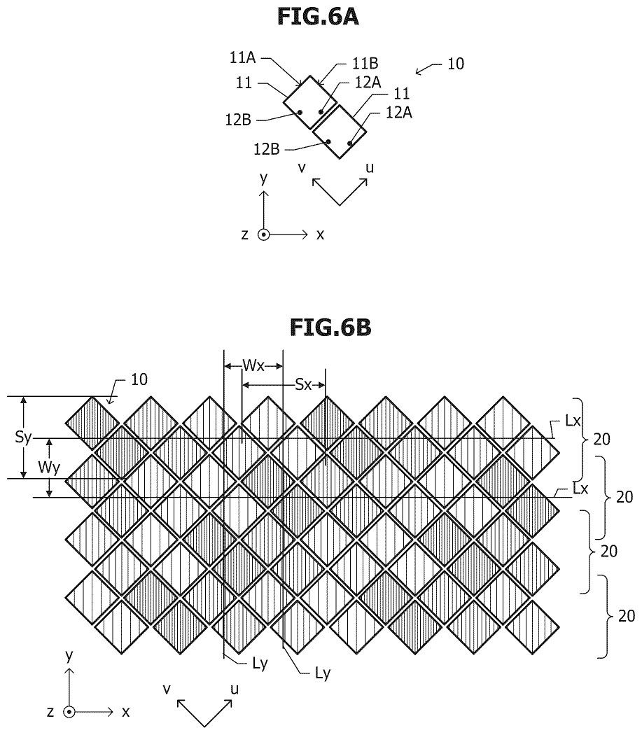

Next, an array antenna according to a third embodiment will be described with reference to FIG. 6A and FIG. 6B. hereinafter, description of the constitutions common to the array antennas according to the first embodiment and its modifications described with reference to FIG. 1A through FIG. 4B will be omitted.

FIG. 6A is a plan view of one subarray 10 of an array antenna according to the third embodiment, and FIG. 6B is a plan view of the array antenna according to the third embodiment. In the third embodiment, multiple subarrays 10 are also arranged two-dimensionally in the x-direction and y-direction, and are arranged along a straight line Lx in the x-direction. In FIG. 6B, as in FIG. 1B, the two radiating elements 11 that constitute one subarray 10 are hatched with the same density.

In the first embodiment (FIG. 1A), two radiating elements 11 in one subarray 10 are arranged side-by-side in the y-direction, but in the third embodiment, the radiating elements 11 included in each of the multiple subarrays 10 are arranged so as to be shifted in a direction inclined with respect to both the x-direction and y-direction. For example, as shown in FIG. 6A, the u-direction and v-direction are inclined at 45 degrees with respect to the x-direction and y-direction, and two radiating elements 11 are arranged side-by-side in the v-direction. Furthermore, the two radiating elements 11 included in each of the multiple subarrays 10 are arranged so that the radiating elements 11 overlap with each other in both the x-direction and y-direction.

Furthermore, in the first embodiment (FIG. 1B), one of the two subarray rows 20 adjacent in the y-direction is shifted in the x-direction by ½ of the arrangement pitch Px relative to the other. In contrast, in the third embodiment, when focusing on the two subarray rows 20 adjacent to each other in the y-direction, if one subarray row 20 is translated in the y-direction, it will overlap the other subarray row 20. In other words, the multiple subarrays 10 are arranged along a straight line in the y-direction as well.

In the third embodiment, as in the first embodiment, the spacing Wy in the y-direction between straight lines Lx parallel to the x-direction that connect the geometric centers of the multiple subarrays 10 included in each of the multiple subarray rows 20 is narrower than the dimension Sy of each of the multiple subarrays 10 in the y-direction. Furthermore, in the third embodiment, the spacing Wx between straight lines Ly parallel to the y-direction that connect the geometric centers of the multiple subarrays 10 aligned in the y-direction is narrower than the dimension Sx of each of the multiple subarrays 10 in the x-direction.

Next, the advantageous effects of the third embodiment will be explained.

In the third embodiment, similarly to the first embodiment, the spacing Wy in the y-direction between straight lines Lx parallel to the x-direction connecting the geometric centers of the multiple subarrays 10 included in each of the multiple subarray rows 20 is narrower than the dimension Sy of each of the multiple subarrays 10 in the y-direction. This allows for a larger beam deflection angle in the y direction.

Furthermore, in the third embodiment, within one subarray row 20, portions of the two subarrays 10 adjacent to each other in the x-direction are arranged in a common range in the x-direction. In other words, the two subarrays 10 overlap with each other in the x-direction. Therefore, compared to a configuration in which the two subarrays 10 are arranged so as not to overlap, the beam deflection angle in the x-direction could be larger.

### Fourth Embodiment

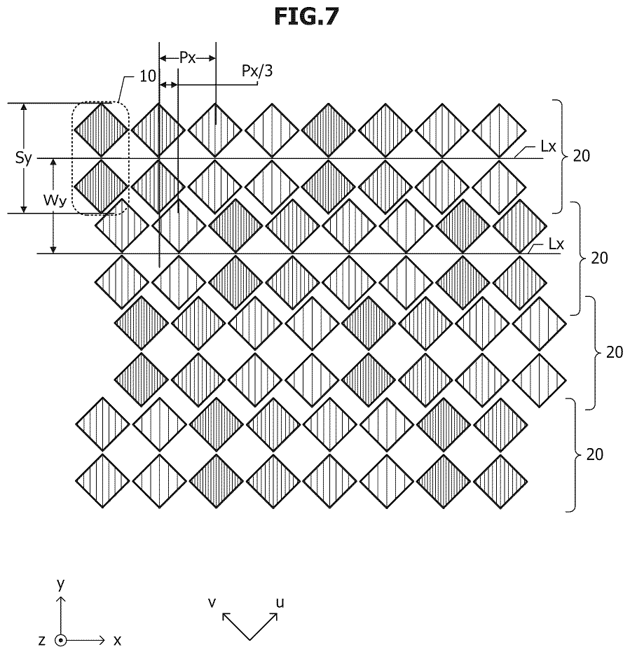

Next, an array antenna according to the fourth embodiment will be described with reference to FIG. 7. Hereinafter, description of the constitutions common to the array antennas according to the first embodiment and its modifications described with reference to FIG. 1A through FIG. 4B will be omitted.

FIG. 7 is a plan view of an array antenna according to the fourth embodiment. In the first embodiment (FIG. 1B), when focusing on two of the multiple subarray rows 20 adjacent to each other in the y-direction, the multiple subarrays 10 included in one subarray row 20 are shifted in the x-direction by ½ of the arrangement pitch Px with respect to the multiple subarrays 10 included in the other subarray row 20. In contrast, in the fourth embodiment, when focusing on the two subarray rows 20 adjacent to each other in the y-direction, the multiple subarrays 10 included in one subarray row 20 are shifted in the x-direction by ⅓ of the arrangement pitch Px with respect to the multiple subarrays 10 included in the other subarray row 20.

More specifically, the subarrays 10 in the subarray row 20 on the negative side of the y-axis are shifted by Px/3 to the positive side of the x-axis. Therefore, in the entire array antenna, the multiple subarrays 10 are arranged in the x-direction at an arrangement pitch of Px/3. In the y-direction, similarly to the first embodiment, the two subarrays 10 are arranged so as to overlap with each other.

Next, the advantageous effects of the fourth embodiment will be explained.

In the fourth embodiment, similarly to the first embodiment, the beam deflection angle could be increased in the y-direction. Furthermore, the beam deflection angle could be further increased in the x-direction. As in the fourth embodiment, the amount of shift in the x-direction between the two subarray rows 20 adjacent to each other in the y-direction may be set to Px/3, or more generally, to Px/n (n is an integer greater than or equal to 2). The multiple subarrays 10 as a whole may be arranged at equal pitches in the x-direction.

### Fifth Embodiment

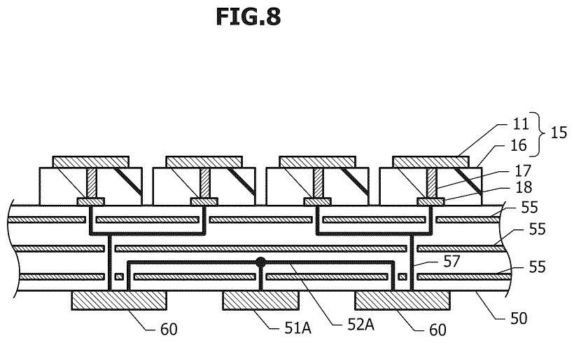

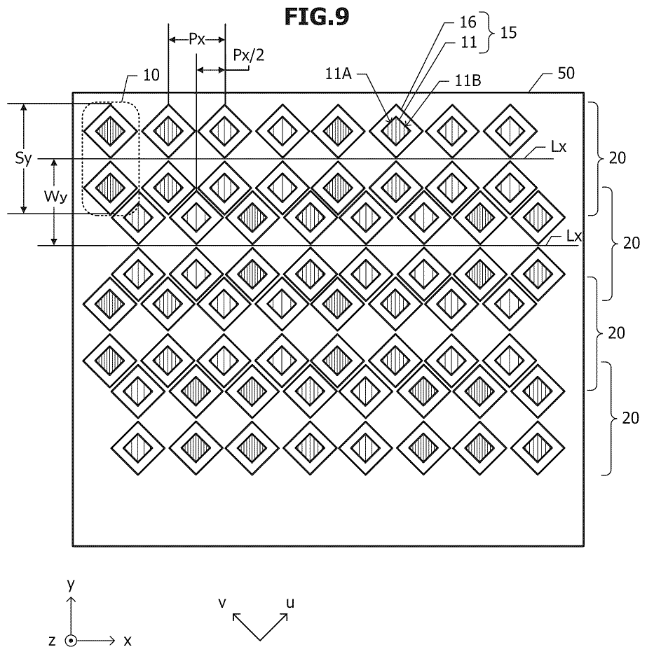

Next, an array antenna according to the fifth embodiment will be described with reference to FIG. 8 and FIG. 9. Hereinafter, description of the configurations common to the array antennas according to the first embodiment and its modifications described with reference to FIG. 1A through FIG. 4B will be omitted.

FIG. 8 is a cross-sectional view of a portion of the array antenna according to the fifth embodiment. In FIG. 8, the array antenna is depicted in a state where the cross-sectional view of the array antenna according to the first embodiment shown in FIG. 3 is turned upside down. Note that while in FIG. 3 the depiction of the ground conductors in the inner layers of the multilayer board 50 is omitted, in FIG. 8 ground conductors 55 in multiple layers are depicted. The ground conductors 55 provide a ground potential to the first branch transmission line 52A, the second branch transmission line 52B (FIG. 2), and the feed line 57.

In the array antenna according to the first embodiment (FIG. 3), the radiating elements 11 are disposed on one surface of the multilayer board 50. In contrast, in the fifth embodiment, multiple dielectric boards 16 are mounted on one surface of the multilayer board 50, and the radiating element 11 is formed on each of the multiple dielectric boards 16. For example, the radiating elements 11 are respectively formed on the surfaces of the dielectric boards 16 opposite to the surfaces facing the multilayer board 50.

The dielectric board 16 and the radiating element 11 formed thereon are collectively referred to as a radiating block 15. Each of the radiating blocks 15 includes one dielectric board 16 and one radiating element 11. Two connection terminals 18 are formed on the surface of each dielectric board 16 facing the multilayer board 50. In the cross section shown in FIG. 8, only one connection terminal 18 appears for each radiating block 15. The other connection terminal is disposed at a location other than the cross section shown in FIG. 8.

The first feed point 12A and the second feed point 12B (FIG. 1A) of the radiating element 11 are respectively connected to the two connection terminals 18 through via conductors 17. The multiple connection terminals 18 are respectively connected to the high-frequency circuit 60 through feed lines 57. In FIG. 3, the first feed points 12A and the second feed point 12B of each of the multiple radiating elements 11 are respectively connected to the high-frequency circuit 60 through feed lines 57 provided separately for each feed point. In FIG. 8, the feed line 57 extending from the high-frequency circuit 60 branches midway, and the two branched feed lines are connected to one feed point of each of the two radiating elements 11. The line length from the branch point of the feed line 57 to one feed point is equal to the line length to the other feed point. In the fifth embodiment, similarly to the first embodiment (FIG. 3), the feed line 57 may be provided for each feed point.

The multiple dielectric boards 16 could be mounted on the multilayer board 50 using, for example, solder. Alternatively, if resins are used as the dielectric material for both the dielectric boards 16 and the multilayer board 50, the dielectric boards 16 could be mounted on the multilayer board 50 by bringing the dielectric boards 16 into contact with the multilayer board 50. As another example, even if resin is used for one of the dielectric boards 16 and the multilayer board 50 and ceramic is used for the other, the dielectric boards 16 could be mounted on the multilayer board 50 by contacting them with the multilayer board 50. In this case, examples of methods for mounting the dielectric boards 16 on the multilayer board 50 include soldering method, and chemical or mechanical bonding methods using the application of temperature, pressure, an electric field, etc.

FIG. 9 is a plan view of the array antenna according to the fifth embodiment.

One subarray 10 is composed of two radiating blocks 15. As with the array antenna according to the first embodiment (FIG. 1B), the multiple subarrays 10 are arranged two-dimensionally in a first direction (x-direction) and a second direction (y-direction) that are parallel to the in-plane direction of the multilayer board 50 and orthogonal to each other. In the x-direction, the multiple subarrays 10 are arranged along a straight line Lx to form multiple subarray rows 20. The two radiating blocks 15 included in each subarray 10 are arranged side by side in the y-direction.

As with the array antenna of the first embodiment (FIG. 1B), each of the radiating elements 11 includes a pair of first edges 11A parallel to a third direction (u-direction) inclined with respect to the x-direction and y-direction, and a pair of second edges 11B parallel to a v-direction perpendicular to the u-direction.

In a plan view, each of the multiple dielectric boards 16 is a square with edges parallel to the first edges 11A and the second edges 11B of each radiating element 11. Here, “square” does not mean a geometrically strict square, but includes a rounded square with rounded corners, and a square with linearly chamfered corners, and the like. In a plan view, each of the multiple dielectric boards 16 is larger than the radiating element 11 and encompasses the radiating element 11. As an example, the length of one side of the radiating element 11 is ½ of the effective wavelength of the radiated radio waves, taking into account the dielectric constant of the dielectric board 16, and the length of one side of the dielectric board 16 is ½ of the free-space wavelength of the radiated radio waves.

The arrangement of the multiple subarrays 10 is the same as in the first embodiment (FIG. 1B). That is, the straight line Lx connecting the geometric centers of the multiple subarrays 10 included in each of the multiple subarray rows 20 is parallel to the x-direction. Furthermore, the relationship between the dimension Sy and the spacing Wy is the same as that of the first embodiment (FIG. 1B). Furthermore, focusing on the two subarray rows 20 adjacent to each other in the y-direction, the amount of deviation in the x-direction between the multiple subarrays 10 included in one subarray row 20 and the multiple subarrays 10 included in the other subarray row 20 is ½ of the arrangement pitch Px in the x-direction of the multiple subarrays 10 that constitute each of the multiple subarray rows 20.

When focusing on the two subarray rows 20 adjacent to each other in the y-direction, each of the multiple radiating blocks 15 of the multiple subarrays 10 included in one subarray row 20 partially overlaps one of the multiple radiating blocks 15 included in the other subarray row 20 with respect to the x-direction. Here, “A and B partially overlap with respect to the x-direction” means that a portion of A and a portion of B are arranged in the same range in the x-direction. For example, in the example shown in FIG. 9, approximately the right half of the two radiating blocks 15 at the left end of the first subarray row 20 is arranged in the same range in the x-direction as approximately the left half of the two radiating blocks 15 at the left end of the second subarray row 20.

Furthermore, at least one radiating block 15 of the multiple subarrays 10 included in one subarray row 20 partially overlaps one of the multiple radiating blocks 15 included in the other subarray row 20 with respect to the y-direction. For example, in the example shown in FIG. 9, approximately the lower half of the multiple radiating blocks 15 on the lower side of the first subarray row 20 is arranged in the same range in the y-direction as approximately the upper half of the multiple radiating blocks 15 on the upper side of the second subarray row 20.

The “partial overlap of the radiating blocks 15” includes a case where the radiating elements 11 included in the radiating blocks 15 partially overlap, and a case where the dielectric boards 16 of the radiating blocks 15 partially overlap but the radiating elements 11 do not.

### Next, the Advantageous Effects of the Fifth Embodiment Will Be described.

In the fifth embodiment, similarly to the first embodiment, multiple subarrays 10 are arranged so as to partially overlap with each other in the x-direction, which allows the beam deflection angle in the x-direction to be increased. Furthermore, the multiple subarrays 10 are arranged so as to partially overlap with each other also in the y-direction, which allows the beam deflection angle in the y-direction to be increased.

Furthermore, in the fifth embodiment, similarly to the first embodiment, the first edges 11A and the second edges 11B of the radiating elements 11 are inclined at 45 degrees with respect to the x-direction and the y-direction, so that the edges of the multiple radiating elements 11 aligned along a straight line in the x-direction are not oppositely arranged in parallel to each other. Furthermore, the edges of two radiating elements 11 within the subarray 10 are also not oppositely arranged in parallel to each other. This increases the isolation between the radiating elements 11.

Furthermore, in the fifth embodiment, the multiple separate radiating blocks 15 are mounted on the multilayer board 50, therefore flexibility in arranging the radiating blocks 15 is increased. Also, by forming the multiple radiating elements 11 on a large dielectric board and then dicing the dielectric board, the multiple radiating blocks 15 (FIG. 8) could be produced. This allows for effective use of the dielectric board, leading to cost reduction.

The volume ratio occupied by the conductor pattern differs between the dielectric board 16 and the multilayer board 50. Therefore, even if the same dielectric material is used for the dielectric board 16 and the multilayer board 50, there will be a difference in the thermal expansion coefficient between the two. In the fifth embodiment, since the dielectric board 16 is separated into each radiating block 15, warping due to the difference in the thermal expansion coefficient between the multilayer boards 50 and the dielectric board 16 is unlikely to occur.

Next, a modification of the fifth embodiment will be described.

In the fifth embodiment, the connection terminals 18 (FIG. 8) are in direct contact with the respective feed lines 57 arranged in the multilayer board 50. Alternatively, the connection terminals 18 and the feed lines 57 may be capacitively coupled or inductively coupled. The radiating elements 11 may be electrically or magnetically coupled to the respective feed lines 57.

In the fifth embodiment (FIG. 8), a patch antenna is formed by the ground conductor 55 in the multilayer board 50 that is located at the shallowest position as viewed from the surface on which the radiating blocks 15 are mounted, and each of the multiple radiating elements 11. As another configuration example, a ground conductor may be provided on the surface of each of the multiple dielectric boards 16 that faces the multilayer board 50. In this configuration, the patch antenna is formed by the ground conductor provided on the dielectric board 16 and the radiating element 11.

### Sixth Embodiment

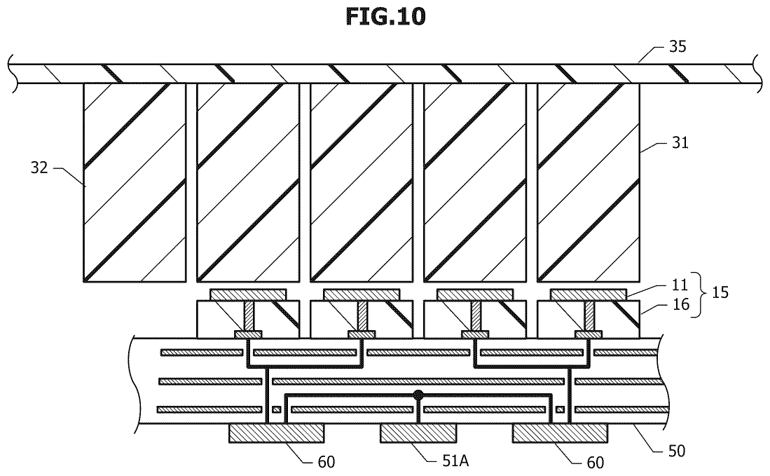

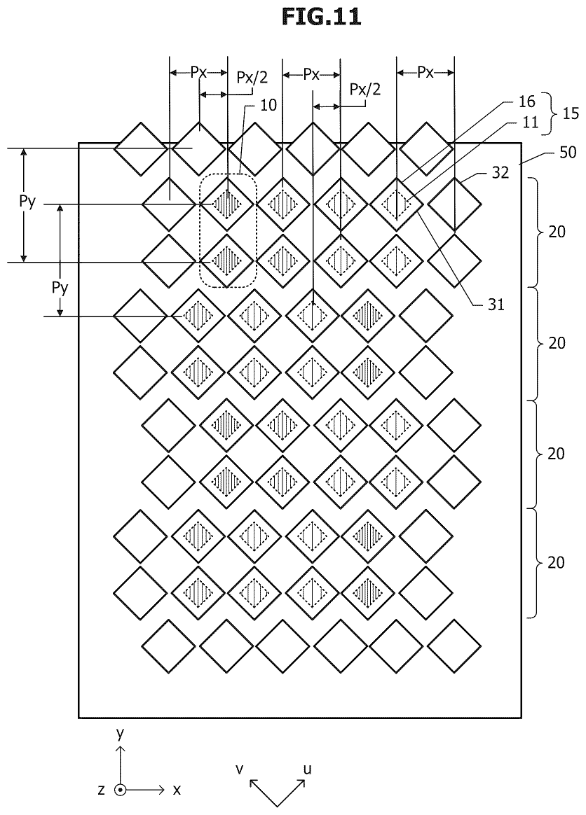

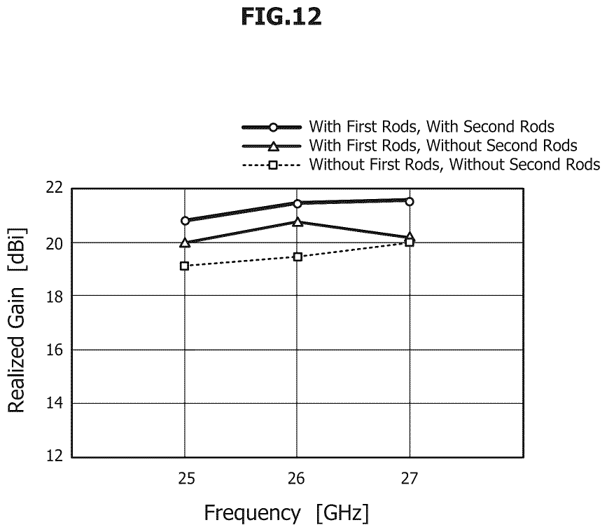

Next, an array antenna according to the sixth embodiment will be described with reference to FIG. 10, FIG. 11, and FIG. 12. Hereinafter, description of the configurations common to the array antenna according to the fifth embodiment described with reference to FIG. 8 and FIG. 9 will be omitted.

FIG. 10 is a cross-sectional view of a portion of an array antenna according to the sixth embodiment. In the sixth embodiment, a plurality of first rods 31, a plurality of second rods 32, etc. are added to the array antenna according to the fifth embodiment (FIG. 8). The first rods 31 made of a dielectric material are arranged for respective radiating elements 11. Each of the multiple first rods 31 extends in the boresight direction from the corresponding radiating element 11. The shape and area of a cross section of each of the first rods 31 perpendicular to the boresight direction are constant in the boresight direction. The “boresight direction” refers to the normal direction of the surface of the multilayer board 50 on which the multiple radiating blocks 15 are mounted.

A minute gap filled with air is provided between the radiating element 11 and the first rod 31. The reason for providing the gap between the radiating element 11 and the first rod 31 is to suppress fluctuations in the resonant wavelength of the radiating element 11 due to the first rod 31.

Second rods 32 are arranged adjacent to the outermost first rods 31 among the multiple first rods 31. The second rods 32 are made of the same dielectric material as the first rods 31. While one second rod 32 is shown in FIG. 10, multiple second rods 32 are arranged in locations other than the cross section shown in FIG. 10. The positional relationship between the first rods 31 and the second rods 32 will be explained later with reference to FIG. 11. The first rods 31 and the second rods 32 have the same shape and dimensions. Similarly to the first rods 31, each of the second rods 32 extends in a direction parallel to the boresight direction.

The multiple first rods 31 and the multiple second rods 32 are supported by a radome 35 made of a dielectric material. For example, the multiple first rods 31 and the multiple second rods 32 are fixed to the radome 35 at their respective tip end surfaces. The radome 35 is fixed to a housing that houses the multilayer board 50. In other words, the relative positions of the multiple first rods 31 with respect to the multiple radiating elements 11 are fixed via the housing and the radome 35.

FIG. 11 is a diagram showing the positional relationship in a plan view among the multiple radiating blocks 15, the multiple first rods 31, and the multiple second rods 32 of the array antenna according to the sixth embodiment. Here, “in a plan view” means when the surface of the multilayer board 50 is viewed from above.

Multiple subarrays 10, each of which consists of two radiating blocks 15, are arranged in four rows and four columns. The positional relationship of the multiple subarrays 10 with respect to the x-direction is the same as the positional relationship of the multiple subarrays 10 with respect to the x-direction in the fifth embodiment (FIG. 9). In the sixth embodiment, the multiple subarrays 10 do not overlap with each other in the y-direction.

The multiple first rods 31 are arranged corresponding to the multiple radiating blocks 15, respectively. In a plan view, each of the multiple first rods 31 has a shape and size that roughly matches the dielectric board 16 of the radiating block 15. In other words, the shape of each of the first rods 31 in a plan view is square. The sides of this square are parallel to the u-direction or the v-direction.

In a plan view, the multiple second rods 32 are arranged around the area in which the multiple radiating blocks 15 are distributed, surrounding the multiple radiating blocks 15. In a plan view, each of the multiple first rods 31 and each of the multiple second rods 32 have the same shape. Furthermore, by translating each of the second rods 32 in the in-plane direction of the multilayer board 50, it is possible to align it with one of the first rods 31. Because the multiple second rods 32 are fixed to the radome 35 (FIG. 10), a portion of the second rod 32 may protrude to the outside of the multilayer board 50 in a plan view.

The multiple first rods 31 are arranged periodically in the x-direction and the y-direction, and the multiple second rods 32 are arranged at positions that inherit the periodicity of the multiple first rods 31 in the x-direction and the y-direction. In other words, the multiple first rods 31 and the multiple second rods 32 are arranged periodically in the x-direction and the y-direction as a whole.

For example, the second rods 32 are arranged at positions obtained by translating the positions of the multiple first rods 31 arranged on the outermost sides in the x-direction by the arrangement pitch Px further outward in the x-direction.

Next, the periodicity in the y-direction will be explained. When the multiple first rods 31 included in one subarray row 20 are translated in the y-direction by the pitch Py and shifted in the x-direction by ½ of the arrangement pitch Px, they overlap the multiple first rods 31 included in the adjacent subarray row 20. In this way, the multiple first rods 31 have periodicity in the y-direction, with the subarray row 20 as a unit.

The multiple first rods 31 included in the outermost subarray row 20 in the y-direction are arranged in two rows parallel to the x-direction. The second rods 32 are arranged at positions where the multiple first rods 31 in the inner row among the multiple first rods 31 arranged in the two rows included in the outermost subarray row 20 in the y-direction, are translated outward by the pitch Py and shifted by ½ of the arrangement pitch Px in the x-direction.

Next, the advantageous effects of the sixth embodiment will be explained with reference to FIG. 12. FIG. 12 is a graph showing the simulation results of the realized gain in the boresight direction of the array antenna. The horizontal axis represents frequency in units of [GHz], and the vertical axis represents the realized gain in units of [dBi]. In the graph of FIG. 12, the thick-lined circle symbols represent the realized gain of the array antenna according to the sixth embodiment, which has the first rods 31 and the second rods 32. The thin-lined triangle symbols represent the realized gain of an array antenna which has the first rods 31 but no second rod 32. The dashed-lined square symbols represent the realized gain of an array antenna which has neither the first rods 31 nor the second rods 32.

The dimensions of the radiating elements 11 and the dielectric constant of the dielectric portions are designed so that the resonant frequency of each of the radiating elements 11 is approximately 26 GHz to 27 GHz. A high-frequency signal of the same phase is supplied to all the radiating elements 11. It could be seen that adding the multiple first rods 31 to the array antenna that does not have either first rods 31 or second rods 32 increases the realized gain in the boresight direction. This is because the radio waves radiated from the radiating elements 11 propagate preferentially within the first rods 31, thereby reducing the radiation intensity in oblique directions.

Adding the second rods 32 in addition to the first rods 31 further increases the realized gain in the boresight direction. This is because the periodic disturbance when focusing on the radiating elements 11 located at the outermost position in a plan view is alleviated.

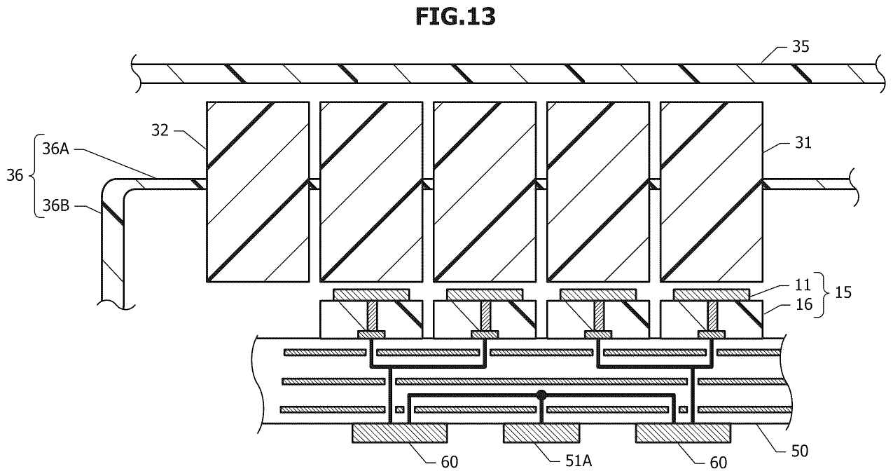

Next, a modification of the sixth embodiment will be described with reference to FIG. 13. FIG. 13 is a cross-sectional view of a portion of an array antenna according to the modification of the sixth embodiment. In the sixth embodiment (FIG. 10), the multiple first rods 31 and the multiple second rods 32 are supported by a radome 35. In contrast, in the modification of the sixth embodiment shown in FIG. 13, the multiple first rods 31 and the multiple second rods 32 are supported by a rod support member 36.

The rod support member 36 is formed of a dielectric material and includes a flat plate portion 36A arranged parallel to the multilayer board 50 and a sidewall portion 36B extending downward from the edge of the flat plate portion 36A toward the multilayer board 50. The multiple first rods 31 and the multiple second rods 32 are fixed to the flat plate portion 36A. The sidewall portion 36B is connected to other portions within the antenna module, such as the side surface of the radome 35 or the surface of the multilayer board 50, thereby the rod support member 36 is supported to the multilayer board 50.

In this modification, the tips of the first rods 31 and the second rods 32 do not need to contact the radome 35. For example, gaps filled with air are provided between the tips of the first rods 31 and the second rods 32 and the radome 35.

In this modification, the radome 35 does not have the function of directly supporting the first rods 31 and the second rods 32, and therefore the degree of freedom in the shape of the radome 35 is increased.

### Next, other modifications of the sixth embodiment will be described.

In the sixth embodiment (FIG. 10), gaps are provided between the first rods 31 and the respective radiating elements 11, and these gaps are filled with air. As an alternative configuration, these gaps may be filled with a dielectric material having a lower dielectric constant than that of the first rods 31. Because the dielectric constant of the dielectric material in contact with the radiating elements 11 is lower than that of the first rods 31, the deviation in the resonant frequency of each of the radiating elements 11 could be suppressed compared to a configuration in which the first rods 31 are in contact with the respective radiating elements 11. By filling the gaps with a low-dielectric-constant material, the dimensions of the gap are stabilized, which is an advantageous effect.

If the dimensions of the radiating elements 11 are designed under the condition that the first rods 31 are in contact with the respective radiating elements 11, the first rods 31 may be in contact with the respective radiating elements 11.

In the sixth embodiment (FIG. 11), the subarrays 10 do not overlap with respect to the y-direction, but as in the fifth embodiment (FIG. 9), the multiple subarrays 10 may be arranged so that they overlap with respect to the y-direction. Furthermore, in the sixth embodiment, as in the first embodiment (FIG. 1B), the multiple subarrays 10 may be arranged so that the radiating elements 11 included in the multiple subarrays 10 overlap with each other in the x-direction and y-direction.

In the sixth embodiment (FIG. 11), the multiple first rods 31 roughly overlap the respective dielectric boards 16 of the multiple radiating blocks 15 in a plan view, but one of the first rods 31 and the dielectric boards 16 may also be configured to encompass the other. The radiating elements 11 may be configured to be encompassed by the respective first rods 31 in a plan view.

In the sixth embodiment (FIG. 11), the multiple second rods 32 are arranged at positions that inherit the periodicity of the multiple first rods 31, but it is not necessary to strictly inherit the periodicity. The multiple second rods 32 may be positioned slightly shifted from the positions where they inherit the periodicity of the multiple first rods 31. Even in this case, when focusing on the outermost first rods 31, the disruption of periodicity could be alleviated by positioning the second rods 32.

In the sixth embodiment, the multiple first rods 31 and the multiple second rods 32 are added to the array antenna according to the fifth embodiment described with reference to FIG. 8 and FIG. 9.

Alternatively, the multiple first rods 31 and the multiple second rods 32 may be added to the array antenna according to the first embodiment and its modifications described with reference to FIG. 1A through FIG. 4B. The positional relationship between the multiple radiating elements 11 of the array antenna according to the first embodiment and the multiple first rods 31 added to the array antenna according to the first embodiment may be the same as the positional relationship between the multiple radiating blocks 15 and the multiple first rods 31 in the sixth embodiment. Furthermore, the multiple second rods 32 may be positioned so that the positional relationship between the multiple first rods 31 and the multiple second rods 32 is the same as that in the sixth embodiment.

In the sixth embodiment (FIG. 10), each of the multiple first rods 31 and the multiple second rods 32 has a uniform thickness in the boresight direction. Alternatively, each of the multiple first rods 31 may have a tapered shape that narrows from the tip facing the radome 35 toward the multilayer board 50.

When each of the first rods 31 is given this tapered shape, the radio wave radiated from each of the multiple radiating elements 11 is more likely to be spread out in a direction oblique to the boresight direction. As a result, the difference between the antenna gain in the boresight direction and the antenna gain in the oblique direction is reduced. In this way, it is possible to adjust the balance of the antenna gain between the boresight direction and the oblique direction.

Furthermore, the multiple second rods 32 may also have the same tapered shape as the multiple first rods 31. By matching the shape of each of the second rods 32 to the shape of each of the first rods 31, it is possible to maintain a high degree of periodicity in the arrangement of the multiple first rods 31 and the multiple second rods 32.

Furthermore, the multiple first rods 31 do not necessarily have to be arranged over the entire area in which the multiple radiation blocks 15 are arranged. For example, the multiple first rods 31 may be arranged for only some of the radiation blocks 15. Furthermore, the multiple second rods 32 do not necessarily have to be arranged so as to surround the entire periphery of the area in which the multiple radiation blocks 15 are arranged. For example, they may be arranged along a portion of a closed curve that surrounds the area in which the multiple radiation blocks 15 are arranged.

The above-described embodiments are merely illustrative, and it goes without saying that partial substitution or combination of the features shown in different embodiments is possible. Similar advantageous effects resulting from similar features in multiple embodiments will not be mentioned sequentially for each embodiment. Furthermore, the present invention is not limited to the above-described embodiments. For example, it will be obvious to those skilled in the art that various modifications, improvements, combinations, etc. are possible.

### EXPLANATION OF SYMBOLS

10 Subarray
11 Radiating Element
11A First Edge
11B Second Edge
12A First Feed Point
12B Second Feed Point
15 Radiating Block
16 Dielectric Board
17 Via Conductor
18 Connection Terminal
20 Subarray Row
31 First Rod
32 Second Rod
35 Radome
36 Rod Support Member
36A Flat Plate Portion
36B Sidewall Portion
50 Multilayer Board
51A First Mixer
51B Second Mixer
52A First Branch Transmission Line
52B Second Branch Transmission Line
55 Ground Conductor
57 Feed Line
60 High-Frequency Circuit

1. An array antenna comprising:
a board; and
a plurality of subarrays, each including a plurality of radiating elements, arranged two-dimensionally in a first direction and a second direction that are parallel to the in-plane direction of the board and orthogonal to each other, and arranged along straight lines in the first direction to form a plurality of subarray rows;
wherein the plurality of radiating elements included in each of the subarrays include conductor patterns having a pair of first edges parallel to a third direction inclined with respect to the first direction and the second direction, and a pair of second edges orthogonal to the third direction, and
wherein the spacing in the second direction between straight lines parallel to the first direction that connect geometric centers of the subarrays included in each of the subarray rows is narrower than the dimension of each of the subarrays in the second direction.

2. The array antenna according to claim 1, wherein the plurality of radiating elements included in each of the subarrays are arranged side by side in the second direction.

3. The array antenna according to claim 2, wherein, for any two of the subarray rows adjacent to each other in the second direction, the subarrays included in one subarray row are arranged to be shifted in the first direction relative to the subarrays included in the other subarray row.

4. The array antenna according to claim 3, wherein, for any two subarray rows adjacent to each other in the second direction, each of the plurality of subarrays included in one subarray row is arranged so as to partially overlap with one of the subarrays included in the other subarray row in the first direction.

5. The array antenna according to claim 3, wherein the subarrays included in the one subarray row are arranged to be shifted in the first direction by Px/n relative to the subarrays included in the other subarray row, wherein Px is an arrangement pitch of the subarrays in the first direction within each subarray row, and n is an integer greater than or equal to 2.

6. An array antenna according to claim 2, wherein the third direction is inclined at 45 degrees with respect to the first direction.

7. The array antenna according to claim 1, wherein the plurality of radiating elements included in each of the subarrays are arranged so as to be shifted in a direction inclined with respect to both the first direction and the second direction, and overlap with each other with respect to both the first direction and the second direction,
and wherein the subarrays are arranged along a straight line with respect to the second direction.

8. The array antenna according to claim 1, further comprising:
a plurality of first rods made of a dielectric material and are arranged such that each of the first rods overlaps and extends beyond a perimeter of a corresponding radiating element in a plan view of the board;
a plurality of second rods made of a dielectric material that are arranged around the area in which the radiating elements are distributed, so as to surround the plurality of radiating elements in a plan view of the board, and extend in a direction parallel to the boresight direction.

9. The array antenna according to claim 8, wherein:
each of the plurality of first rods and each of the plurality of second rods have the same shape in a plan view of the board; and
the first rods are arranged periodically in the first direction and the second direction, and the plurality of second rods are arranged at positions that inherit the periodicity of the plurality of first rods in the first direction and the second direction.

10. The array antenna according to claim 1, wherein each of the plurality of radiating elements includes a first feed point and a second feed point configured to excite and receive orthogonally polarized signals.

11. An array antenna comprising:
a multilayer board; and
a plurality of subarrays, each including a plurality of radiating blocks, arranged two-dimensionally in a first direction and a second direction parallel to an in-plane direction of the multilayer board and orthogonal to each other, and arranged along a straight line in the first direction to form a plurality of subarray rows;
wherein:
each of the plurality of radiating blocks includes a dielectric board mounted on the multilayer board and a radiating element on the dielectric board;
each of the plurality of radiating elements includes a conductor pattern having a pair of first edges parallel to a third direction inclined with respect to the first direction and the second direction, and a pair of second edges orthogonal to the third direction;
each of the dielectric boards is square or rectangular in a plan view, with edges parallel to the first edges and the second edges of each of the radiating elements; and
for any two subarray rows adjacent to each other in the second direction, each of the plurality of radiating blocks of the plurality of subarrays included in one subarray row is arranged so as to partially overlap with any one of the plurality of radiating blocks included in the other subarray row in the first direction.

12. The array antenna according to claim 11, wherein, for any two subarray rows adjacent to each other in the second direction, at least one radiating block of the plurality of subarrays included in one subarray row is arranged to partially overlap any one of the plurality of radiating blocks included in the other subarray row in the second direction.

13. The array antenna according to claim 11, further comprising:
a plurality of first rods made of a dielectric material that encompass at least some of the plurality of radiating elements of the respective radiating blocks and extend in a boresight direction from the respective radiating elements in a plan view of the multilayer board; and
a plurality of second rods made of a dielectric material that extend in a direction parallel to the boresight direction and are arranged along at least a portion of a closed curve surrounding the area in which the plurality of radiating blocks are distributed in a plan view of the multilayer board.

14. The array antenna according to claim 13, wherein:
each of the plurality of first rods and each of the plurality of second rods have a same shape in a plan view of the multilayer board; and
the plurality of first rods are arranged periodically in the first direction and the second direction, and the plurality of second rods are arranged at positions that inherit the periodicity of the plurality of first rods in the first direction and the second direction.

15. The array antenna according to claim 13, wherein each of the plurality of first rods has a tapered shape that narrows from its tip toward the multilayer board.

16. The array antenna according to claim 15, further comprising a plurality of second rods, wherein each of the plurality of second rods has a same tapered shape as the plurality of first rods.

17. An antenna module, comprising:
an array antenna including
a board having a first surface and an opposite second surface;
a plurality of subarrays arranged on the first surface of the board, each subarray including a plurality of radiating elements, wherein the subarrays are arranged in a plurality of subarray rows;
a plurality of high-frequency circuits mounted on the second surface of the board and electrically coupled to the plurality of subarrays; and
at least one mixer mounted on the second surface of the board and coupled to the plurality of high-frequency circuits via at least one branch transmission line.

18. The antenna module according to claim 17, wherein each radiating element is mounted on a corresponding discrete dielectric board.
